(19) United States
(12) Patent Application Publication
(10) Pub. No.: US 2024/0258753 A1
(43) Pub. Date: Aug. 1, 2024

(54) Female Connector, Male Connector, Connector Assembly, and Vehicle-Mounted Device

(71) Applicant: Huawei Technologies Co., Ltd., Shenzhen (CN)

(72) Inventors: Huiru Yan, Dongguan (CN); Chen Gong, Dongguan (CN); Haifeng Tong, Dongguan (CN)

(21) Appl. No.: 18/591,674

(22) Filed: Feb. 29, 2024

Related U.S. Application Data
(63) Continuation of application No. PCT/CN2022/113553, filed on Aug. 19, 2022.

(30) Foreign Application Priority Data
Aug. 31, 2021 (CN) 202111017392.9

(51) Int. Cl. H01R 27/02; H01R 13/518; H01R 13/6581

(52) U.S. Cl. CPC H01R 27/02; H01R 13/518; H01R 13/6581; H01R 2201/26

(57) ABSTRACT

A female connector, a male connector, a connector assembly, and a vehicle-mounted device are used for intelligent driving or assisted driving. The female connector includes a first insulating body and a first protective housing. The first insulating body is disposed in the first protective housing. A first jack and a second jack are disposed on the first insulating body. The male connector includes a second insulating body and a second protective housing. A first pin and a second pin are convexly disposed on the second insulating body. The second protective housing is disposed around the first pin and the second pin. The first pin and the second pin are respectively configured to transmit signals with different rates. The second protective housing is inserted between the first protective housing and the first insulating body.

### CROSS-REFERENCE TO RELATED APPLICATIONS

This is a continuation of International Patent Application No. PCT/CN2022/113553 filed on Aug. 19, 2022, which claims priority to Chinese Patent Application No. 202111017392.9 filed on Aug. 31, 2021. The disclosures of the aforementioned applications are hereby incorporated by reference in their entireties.

### TECHNICAL FIELD

This application relates to the field of electrical connector technologies, and in particular, to a female connector, a male connector, a connector assembly, and a vehicle-mounted device.

### BACKGROUND

With rapid development of vehicle technologies, a vehicle becomes increasingly electrified and intelligent. Because more electronic devices are disposed on the vehicle, and the electronic devices communicate with each other more frequently, requirements for connection and cabling between vehicle-mounted electronic devices are increasingly high, to improve in-vehicle communication quality and meet a vehicle design requirement. For example, a plurality of sensors may be installed on the vehicle to obtain environment information around the vehicle, and the obtained information is analyzed and processed by a vehicle-mounted processing device, to implement functions such as obstacle sensing, target recognition, vehicle positioning, path planning, and the like, so as to improve safety and an automation degree of vehicle driving. A vehicle-mounted sensor may include, for example, at least one of a lidar, a millimeter wave radar, a camera, and the like. The vehicle-mounted sensor transmits sensed information to the vehicle-mounted processing device. Because an amount of the sensed information increases with an increasing requirement for intelligence, there is a requirement for high-speed transmission between the vehicle-mounted sensor and the vehicle-mounted processing device. In addition, there is a requirement for low-speed transmission of a small amount of data, for example, control information, between the vehicle-mounted processing device and the sensor. Therefore, more cabling space is needed for conventional cabling and connection, which brings a great challenge to a cabling design of the vehicle.

### SUMMARY

Embodiments of this application provide a female connector, a male connector, a connector assembly, and a vehicle-mounted device, to reduce space costs of a connector and improve installation efficiency.

According to an aspect, an embodiment of this application provides a female connector, including a first insulating body, a first protective housing, a first jack, and a second jack. The first insulating body is disposed in the first protective housing, the first jack and the second jack are provided on the first insulating body, the first jack and the second jack are exposed on an opening side of the first protective housing, there is a spacing between the first jack and the second jack, and the first jack and the second jack are respectively configured to transmit signals with different rates.

According to the female connector provided in embodiments of this application, a first jack configured to transmit high-speed Ethernet data and a second jack configured to transmit a low-speed CAN signal and a power supply can be integrated into the first protective housing, to reduce a volume of the connector and plug-in and out durability.

In a possible implementation, the first insulating body includes a first support and a second support, the first jack is provided on the first support, the second jack is provided on the second support, an accommodating cavity is provided on the second support, the first support is installed in the accommodating cavity, and there is a spacing between the first support and an inner wall of the accommodating cavity.

The first support and the second support are disposed, to integrate the first jack and the second jack into the first protective housing. This helps separate the first jack from the second jack, prevents interference when the first jack and the second jack perform signal transmission, and facilitates respective assembly of the first jack and the second jack.

In a possible implementation, the female connector further includes a first shielding housing, the first shielding housing covers the first support, the first jack is exposed on an opening side of the first shielding housing, the first shielding housing is disposed in the accommodating cavity, and there is a spacing between an outer wall of the first shielding housing and the inner wall of the accommodating cavity.

The first shielding housing may cover the first jack, to effectively shield electromagnetic interference and improve overall structural strength of the first jack and the first support.

In a possible implementation, a spring plate is disposed on an outer surface of the first shielding housing.

The spring plate can play a clamping function, so that after a male connector is connected to the female connector, by using the spring plate, the first shielding housing can be clamped on a structure that is of the male connector and that is correspondingly inserted between the first shielding housing and the inner wall of the accommodating cavity, to ensure a more stable and reliable insertion relationship. In addition, the spring plate can fill a middle spacing generated by connecting the male connector and the female connector, to play a shielding function.

In a possible implementation, an opening of the first shielding housing is set to a rectangle, and the spring plate is disposed on each of four side walls that correspond to four sides of the rectangle on the first shielding housing.

Compared with a shielding housing with a circular opening, for a shielding housing with a rectangular opening and a same shielding surface area, more spring plates can be arranged to fill the middle spacing generated by connecting the male connector and the female connector, so that the spacing is less than one-quarter wavelength of an electromagnetic wave as far as possible, to achieve a good shielding effect.

In a possible implementation, a first limiting cavity is provided in the first protective housing, the first limiting cavity is provided opposite to the accommodating cavity, and the first shielding housing is installed in the first limiting cavity.

The first limiting cavity can prevent the first shielding housing from moving inward after being subject to an action force generated by inserting a pin into the first jack.

In a possible implementation, a first limiting slot is provided on an inner side wall of the first limiting cavity, a first limiting boss is disposed on the second support, the first limiting boss is disposed on a side that faces the first limiting cavity and that is of the second support, and is located on a peripheral side of the accommodating cavity, and the first limiting boss is clamped in the first limiting slot.

The first limiting boss may be clamped in the first limiting slot to prevent the second support from moving inward after being subject to a force, and limit a position of the first shielding housing to prevent poor electrical contact caused by moving the first jack up and down.

In a possible implementation, a first conductive terminal is disposed in the first jack, the first conductive terminal is configured to connect to a first connection cable, a second conductive terminal is disposed in the second jack, and the second conductive terminal is configured to connect to a second connection cable.

The first conductive terminal and the second conductive terminal may be a type of conductive structure like a metal spring plate, to ensure, on the basis of implementing an electrical connection, good electrical contact obtained by inserting the pin into a jack.

In a possible implementation, a second limiting cavity is provided in the first protective housing, the second conductive terminal is installed in the second limiting cavity, and the second support covers the second limiting cavity.

The second limiting cavity can prevent the second conductive terminal from moving inward after being subject to an action force generated by inserting the pin into the second jack.

In a possible implementation, the second limiting cavity includes a second limiting slot, a second limiting boss is disposed on the second support, the second limiting boss is disposed on a side that faces the second limiting cavity and that is of the second support, and the second limiting boss is clamped in the second limiting slot.

The second limiting boss may be clamped in the second limiting slot to prevent the second support from moving inward after being subject to a force, and limit a position of the second conductive terminal to prevent poor electrical contact caused by moving the second conductive terminal up and down.

In a possible implementation, a protrusion is disposed on an inner side wall of the second support, a first groove and a second groove are disposed on an outer side wall of the second limiting cavity, the first groove and the second groove are arranged in an extension direction of the second conductive terminal, the first groove is located on a side close to the second jack, and the protrusion is configured to be clamped in the first groove or the second groove.

The first groove and the second groove may be disposed, to facilitate assembly of the second support and the first protective housing, and reduce assembly costs.

In a possible implementation, there are a plurality of second conductive terminals, the second limiting cavity includes a plurality of sub-cavities, and the plurality of second conductive terminals and the plurality of sub-cavities are disposed in a one-to-one correspondence.

In this way, positions of the plurality of second conductive terminals can be reliably limited, and the plurality of sub-cavities can separate the plurality of second conductive terminals, to avoid a contact short circuit.

In a possible implementation, a disassembly groove is disposed on an outer side wall surface of the first insulating body.

Compared with a structure in which the protrusion or a handle is disposed on the second support for disassembly, the disassembly groove is disposed, so that corresponding avoidance processing does not need to be performed on the male connector, and design costs can be reduced.

In a possible implementation, a guiding groove is disposed on an inner side wall of the first protective housing, and the guiding groove extends inward from the opening side of the first protective housing.

The guiding groove is configured to cooperate with a guiding rib and another structure on the male connector to play a guiding function and facilitate a connection between the female connector and the male connector.

According to another aspect, an embodiment of this application provides a male connector, including a second insulating body, a second protective housing, a first pin, and a second pin. The first pin and the second pin are convexly disposed on the second insulating body, the second protective housing is connected to the second insulating body, the second protective housing is disposed around the first pin and the second pin, the first pin and the second pin are exposed on an opening side of the second protective housing, there is a spacing between the first pin and the second pin, and the first pin and the second pin are respectively configured to transmit signals with different rates.

For the male connector provided in embodiments of this application, compared with a manner in which each of the first pin and the second pin is disposed in one protective housing, a manner in which the first pin and the second pin are integrated into the second protective housing can reduce a volume of the male connector.

In a possible implementation, the male connector further includes a second shielding housing, the second shielding housing is disposed around the first pin, and the first pin is exposed on an opening side of the second shielding housing.

The second shielding housing may cover the first pin, to effectively shield electromagnetic interference.

In a possible implementation, the male connector further includes a circuit board, the circuit board is disposed on a side that is far away from the second protective housing and that is of the second insulating body, and the first pin and the second pin penetrate in through holes of the second insulating body and are fastened to the circuit board.

The first pin and the second pin may penetrate the second insulating body and be soldered on the circuit board, to implement an electrical connection to the circuit board while being reliably fastened.

In a possible implementation, the second shielding housing penetrates in a through hole of the second insulating body and is fastened to the circuit board.

In this case, the second shielding housing can cover an entire length of the first pin, to achieve a good shielding effect.

In a possible implementation, the second insulating body is provided with three positioning pins, the three positioning pins are arranged as a triangle, the circuit board is provided with three positioning holes, and the positioning pin penetrates in the positioning hole.

When the first pin and the second pin are soldered on the circuit board, the circuit board can be pre-positioned through cooperation between the positioning pin and the positioning hole, to prevent a pin damage or a soldering failure caused by moving the circuit board in a soldering process.

In a possible implementation, a guiding rib is disposed on an outer side wall of the second protective housing, the guiding rib extends in a direction close to the second insulating body from the opening side of the second protective housing, and an extension direction of the guiding rib is consistent with an extension direction of the first pin and the second pin.

The guiding rib is configured to be clamped in a guiding groove and move in the guiding groove, so that a female connector can move along a fixed position when being inserted into the male connector. In addition, the guiding function facilitates smooth insertion cooperation between a pin and a jack.

In a possible implementation, the male connector further includes a mounting plate, the mounting plate is connected to a periphery of the second insulating body, a mounting hole is provided on the mounting plate, and the mounting hole is configured to mount a fastener to fasten the male connector to a to-be-installed device.

The mounting hole and the mounting plate can be provided, to better fasten the male connector and the to-be-installed device together without loosening.

According to another aspect, an embodiment of this application further provides a connector assembly, including a female connector and a male connector. The female connector includes a first insulating body, a first protective housing, a first jack, and a second jack. The first insulating body is disposed in the first protective housing, the first jack and the second jack are provided on the first insulating body, the first jack and the second jack are exposed on an opening side of the first protective housing, there is a spacing between the first jack and the second jack, and the first jack and the second jack are respectively configured to transmit signals with different rates.

The male connector includes a second insulating body, a second protective housing, a first pin, and a second pin. The first pin and the second pin are convexly disposed on the second insulating body, the second protective housing is connected to the second insulating body, the second protective housing is disposed around the first pin and the second pin, the first pin and the second pin are exposed on an opening side of the second protective housing, there is a spacing between the first pin and the second pin, and the first pin and the second pin are respectively configured to transmit signals with different rates.

The second protective housing is configured to be inserted into accommodating space between the first protective housing and the first insulating body, the first pin is configured to be inserted into the first jack, and the second pin is configured to be inserted into the second jack.

For the connector assembly provided in embodiments of this application, a high-speed connector configured to transmit high-speed Ethernet data and a low-speed connector configured to transmit a low-speed Controller Area Network (CAN) signal and a power supply can be combined, to reduce a volume of the connector, and simultaneously transmit a high-speed signal and a low-speed signal by wiring only once. Convenience and efficiency of a user operation can be improved by reducing plug-in and out durability of the connector. In addition, manufacturing costs of the connector can be greatly reduced by combining the two connectors.

In a possible implementation, the first insulating body includes a first support and a second support, the first jack is provided on the first support, the second jack is provided on the second support, an accommodating cavity is provided on the second support, the first support is installed in the accommodating cavity, and there is a spacing between the first support and an inner wall of the accommodating cavity.

The male connector further includes a second shielding housing, the second shielding housing is disposed around the first pin, the first pin is exposed on an opening side of the second shielding housing, and the second shielding housing is configured to be inserted between the first support and the accommodating cavity.

The second shielding housing is inserted between the first support and the accommodating cavity, so that the second shielding housing can shield electromagnetic signals generated by the first pin and the first jack.

In a possible implementation, the female connector further includes a first shielding housing, the first shielding housing covers the first support, the first jack is exposed on an opening side of the first shielding housing, the first shielding housing is disposed in the accommodating cavity, there is a spacing between an outer wall of the first shielding housing and the inner wall of the accommodating cavity, and the second shielding housing is configured to be inserted between the first shielding housing and the accommodating cavity.

The first shielding housing can further improve a shielding effect.

In a possible implementation, a spring plate is disposed on an outer surface of the first shielding housing, and the spring plate is clamped on an inner wall of the second shielding housing.

The spring plate can improve the shielding effect, and clamp the second shielding housing, so that a connection between the first shielding housing and the second shielding housing is more reliable.

In a possible implementation, a guiding groove is disposed on an inner side wall of the first protective housing, and the guiding groove extends inward from the opening side of the first protective housing.

A guiding rib is disposed on an outer side wall of the second protective housing, the guiding rib extends in a direction close to the second insulating body from the opening side of the second protective housing, an extension direction of the guiding rib is consistent with an extension direction of the first pin and the second pin, and the guiding rib is configured to be clamped in the guiding groove and move in the guiding groove.

Through cooperation between the guiding rib and the guiding groove, the female connector can move along a fixed position when being inserted into the male connector. In addition, the guiding function facilitates smooth insertion cooperation between a pin and a jack.

According to another aspect, an embodiment of this application provides a vehicle-mounted device, including the female connector, the male connector, or the connector assembly.

In a possible implementation, the vehicle-mounted device includes a vehicle-mounted lidar or a vehicle-mounted processing device.

According to another aspect, an embodiment of this application provides a cable, including the female connector or the male connector.

According to another aspect, an embodiment of this application provides a terminal, including the female connector or the male connector.

The connector provided in embodiments of this application that combines the high-speed connector and the low-speed connector can be used in the terminal, to reduce plug-in and out durability and facilitate a miniaturized design of the terminal.

According to the female connector, the male connector, the connector assembly, and the vehicle-mounted device provided in embodiments of this application, the high-speed connector and the low-speed connector can be integrated into one connector, to reduce the size of the connector, facilitate overall miniaturization of the vehicle-mounted device, and simultaneously transmit the high-speed signal and the low-speed signal by wiring only once. Convenience and efficiency of the user operation can be improved by reducing plug-in and out durability of the connector. In addition, the manufacturing costs of the connector can be greatly reduced by combining the two connectors.

### BRIEF DESCRIPTION OF DRAWINGS

FIG. 1 is a schematic diagram of a scenario of a connection between devices according to an embodiment of this application;

FIG. 2 is a schematic diagram of a structure of a device according to an embodiment of this application;

FIG. 3 is a schematic diagram of a structure of a female connector according to an embodiment of this application;

FIG. 4 is a schematic exploded view of a female connector according to an embodiment of this application;

FIG. 5 is a schematic exploded view of a first insulating body according to an embodiment of this application;

FIG. 6 is a schematic diagram of a structure of a first shielding housing according to an embodiment of this application;

FIG. 7 is a schematic diagram of cooperation between a first shielding housing and a second support according to an embodiment of this application;

FIG. 8 is a schematic diagram of a structure of a second support according to an embodiment of this application;

FIG. 9 is a schematic diagram of a structure of a first protective housing according to an embodiment of this application;

FIG. 10 is a schematic diagram of a structure of a first protective housing from another angle according to an embodiment of this application;

FIG. 11 is a front view of a female connector according to an embodiment of this application;

FIG. 12 is a cross sectional view of FIG. 11 at A-A;

FIG. 13 is a cross sectional view of FIG. 11 at B-B;

FIG. 14 is a cross sectional view of FIG. 11 at C-C;

FIG. 15 is an enlarged view of a circle portion of FIG. 14;

FIG. 16 is a schematic diagram of a structure of a male connector according to an embodiment of this application;

FIG. 17 is a schematic diagram of another structure of a male connector according to an embodiment of this application;

FIG. 18 is a schematic exploded view of a male connector according to an embodiment of this application;

FIG. 19 is a schematic diagram of a structure of a male connector from another angle according to an embodiment of this application;

FIG. 20 is a front view of a male connector according to an embodiment of this application; and

FIG. 21 is a schematic diagram of cooperation between a female connector and a male connector according to an embodiment of this application.

### DESCRIPTIONS OF REFERENCE NUMERALS

100—female connector; 11—first insulating body; 111—first support; 112—second support; 1121—first limiting boss; 1122—second limiting boss; 1123—protrusion; 113—accommodating cavity; 114—disassembly groove; 12—first protective housing; 121—first limiting cavity; 122—first limiting slot; 123—second limiting cavity; 1231—sub-cavity; 124—second limiting slot; 125—first groove; 126—second groove; 127—guiding groove; 13—first jack; 132—first connection cable; 14—second jack; 140—opening; 141—second conductive terminal; 142—second connection cable; 15—first shielding housing; 151—spring plate; 152—stop protrusion;
200—male connector; 21—second insulating body; 22—second protective housing; 221—guiding rib; 23—first pin; 24—second pin; 25—second shielding housing; 26—circuit board; 261—positioning hole; 27—positioning pin; 28—mounting plate; 281—mounting hole;
400—cable; 500—vehicle-mounted device.

### DESCRIPTION OF EMBODIMENTS

The terms used in embodiments of this application are only used to explain specific embodiments of this application, but are not intended to limit this application.

With rapid development of vehicle technologies, a vehicle becomes increasingly electrified and intelligent. Because more electronic devices are disposed on the vehicle, and the electronic devices communicate with each other more frequently, requirements for connection and cabling between vehicle-mounted electronic devices are increasingly high, to improve in-vehicle communication quality and meet a vehicle design requirement. For example, a plurality of sensors may be installed on the vehicle to obtain environment information around the vehicle, and the obtained information is analyzed and processed by a vehicle-mounted processing device, to implement functions such as obstacle sensing, target recognition, vehicle positioning, path planning, and the like, so as to improve safety and an automation degree of vehicle driving. A vehicle-mounted sensor may include, for example, at least one of a lidar, a millimeter wave radar, a camera, and the like. The vehicle-mounted sensor transmits sensed information to the vehicle-mounted processing device. Because an amount of the sensed information increases with an increasing requirement for intelligence, there is a requirement for high-speed transmission between the vehicle-mounted sensor and the vehicle-mounted processing device. In addition, there is a requirement for low-speed transmission of a small amount of data, for example, control information, between the vehicle-mounted processing device and the sensor. Therefore, more cabling space is needed for conventional cabling and connection, which brings a great challenge to a cabling design of the vehicle.

In view of this problem, in embodiments of this application, a female connector and a male connector are designed, and are configured to connect devices with high-speed and low-speed transmission requirements. The connector (the female connector or the male connector) occupies less space on the device, and a requirement for communication and cabling between the devices is reduced. This facilitates a miniaturization design of the device (for example, a vehicle-mounted device) in which the connector is used. In addition, wiring can be completed at a time. This reduces operation costs and improves installation efficiency.

The following describes the connector provided in embodiments of this application with reference to the accompanying drawings.

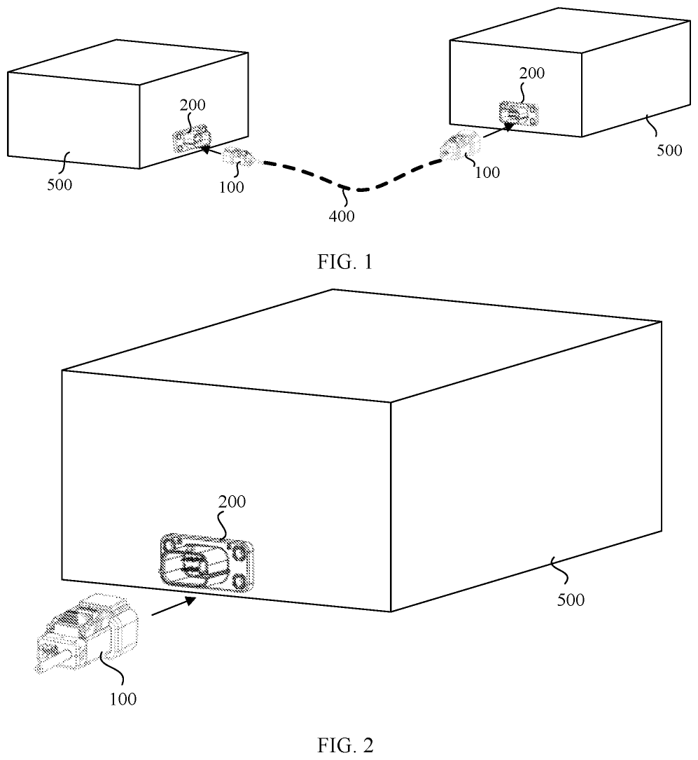

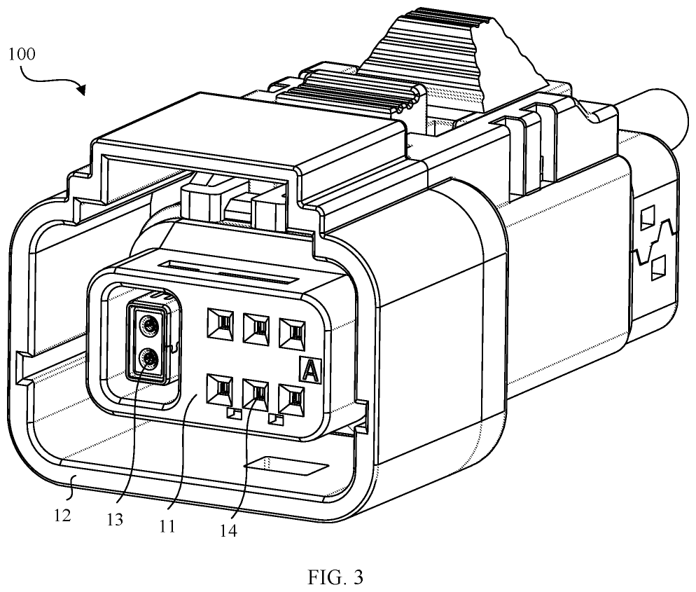

FIG. 1 is a schematic diagram of a scenario of a connection between devices according to an embodiment of this application, and FIG. 2 is a schematic diagram of a structure of a device according to an embodiment of this application. The foregoing devices may be disposed on a vehicle and serve as the vehicle-mounted device. Further, an embodiment of this application may further provide a vehicle. The vehicle may include at least two vehicle-mounted devices 500. The two vehicle-mounted devices 500 may be connected through a cable 400, and a connection between the vehicle-mounted device 500 and the cable 400 may be implemented by using a connector assembly. Vehicle-mounted devices connected through the cable 400 may be a same device, or may be different devices.

The vehicle-mounted device may include but is not limited to a millimeter wave radar, a video radar, a gateway, a telematics BOX (T-BOX), a Global Positioning System (GPS), and an in-vehicle infotainment (IVI). In an implementation, one vehicle-mounted device is a lidar, and the other vehicle-mounted device is a vehicle-mounted processing device, for example, a domain controller or the IVI.

For example, a vehicle-mounted lidar and the domain controller are connected. The vehicle-mounted lidar and the domain controller may be cooperatively connected by using the connector assembly, to implement high-speed Ethernet data transmission, low-speed CAN signal transmission, driving electrical signal (for example, a power signal) transmission, and another-type signal transmission.

The connector assembly may include a female connector 100 and a male connector 200. The female connector 100 and the male connector 200 may be cooperatively connected to implement an electrical connection and transmit data. It should be understood that one of the female connector 100 and the male connector 200 may be disposed on a device body of the vehicle-mounted device 500, and the other may be disposed on the cable 400. In the following embodiments of this application, an example in which the male connector 200 is disposed on the device body and the female connector 100 is connected to an end of the cable 400 is used to describe specific structures of the male connector 200 and the female connector 100.

It should be noted that, in embodiments of this application, insertion cooperation between the structures of the female connector 100 and the male connector 200, and an electrical connection of a conductive terminal may be implemented by inserting a pin into a jack. The pin and the jack may be respectively disposed on the female connector 100 and the male connector 200. Alternatively, the jack and the pin may be respectively disposed on the female connector 100 and the male connector 200.

In the following embodiments of this application, a structure in which the jack is provided on the female connector 100 and the pin is disposed on the male connector 200 is used as an example.

With reference to the accompanying drawings, the following describes in detail a structure of the female connector provided in embodiments of this application.

FIG. 3 is a schematic diagram of a structure of a female connector according to an embodiment of this application. Refer to FIG. 3. An embodiment of this application provides a female connector 100, which may include a first insulating body 11, a first protective housing 12, a first jack 13, and a second jack 14. The first insulating body 11 may be disposed in the first protective housing 12. The first jack 13 and the second jack 14 are provided on the first insulating body 11. The first jack 13 and the second jack 14 are exposed on an opening side of the first protective housing 12. There is a spacing between the first jack 13 and the second jack 14. The first jack 13 and the second jack 14 are respectively configured to transmit signals with different rates.

The first jack 13 may be configured to transmit high-speed Ethernet data. The second jack 14 may be configured to transmit a low-speed CAN signal and/or a power signal. There is a spacing between the first jack 13 and the second jack 14, so that mutual influence between signals can be reduced. That there is a spacing between the first jack 13 and the second jack 14 means that there is a spacing between the first jack 13 and the second jack 14 that are closest to each other. A distance of the spacing is not limited in this embodiment of this application. The spacing may be used to facilitate a design of an interference isolation structure between the first jack 13 and the second jack 14, to improve signal transmission quality. This is described in the following embodiments. Compared with a manner in which each of the first jack 13 and the second jack 14 is disposed in one protective housing, a manner in which the first jack 13 and the second jack 14 are integrated into the first protective housing 12 can reduce a volume of the connector, facilitate a connection, and improve installation efficiency.

A quantity of the first jacks 13 and a quantity of the second jacks 14 are not specifically limited in this embodiment of this application. There may be one or more first jacks 13, and there may be one or more second jacks 14. For example, there may be two first jacks 13 and six second jacks 14. In this case, the first jacks 13 and the second jacks 14 may be arranged from left to right, as shown in FIG. 3. The two first jacks 13 may be arranged from top to bottom in one row. The six second jacks 14 may be arranged in two rows and three columns.

It should be noted that, in this embodiment of this application, shapes of the first insulating body 11 and the first protective housing 12 are not specifically limited. A shape of an opening of the first protective housing 12 may be a rectangle, an ellipse, a polygon, or another shape. A shape of the first insulating body 11 exposed on the opening side of the first protective housing 12 may be similar to that of the first protective housing 12. In this embodiment of this application, the shape of the opening of the first protective housing 12 may be a rounded rectangle. The shape is merely a possible implementation, and does not limit a structure of the first protective housing 12.

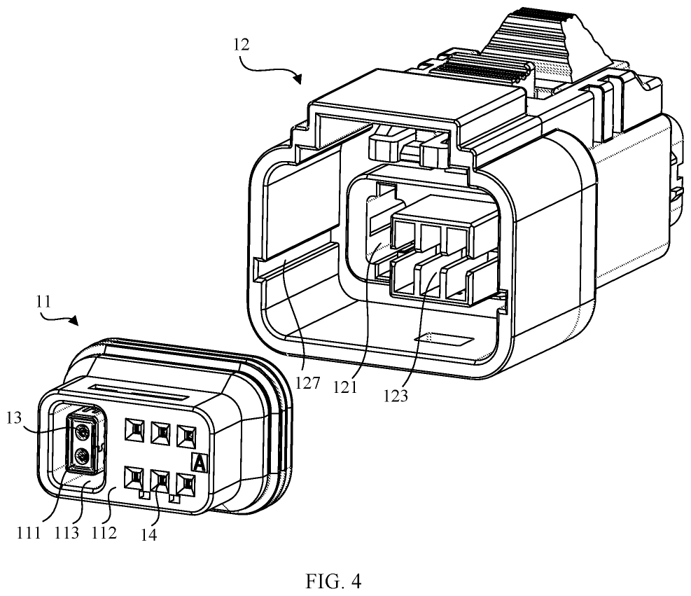

FIG. 4 is a schematic exploded view of a female connector according to an embodiment of this application. Refer to FIG. 4. The first insulating body 11 may include a first support 111 and a second support 112. The first jack 13 may be disposed on the first support 111. The second jack 14 may be disposed on the second support 112. An accommodating cavity 113 may be disposed on the second support 112. The first support 111 may be installed in the accommodating cavity 113. There is a spacing between the first support 111 and an inner wall of the accommodating cavity 113.

The first jack 13 is disposed on the first support 111, the second jack 14 is disposed on the second support 112, and the first support 111 is installed in the accommodating cavity 113 of the second support 112. In this way, when the first jack 13 and the second jack 14 are integrated into the first protective housing 12, the first jack 13 and the second jack 14 can be separated, to prevent interference when the first jack 13 and the second jack 14 perform signal transmission and facilitate respective assembly of the first jack 13 and the second jack 14.

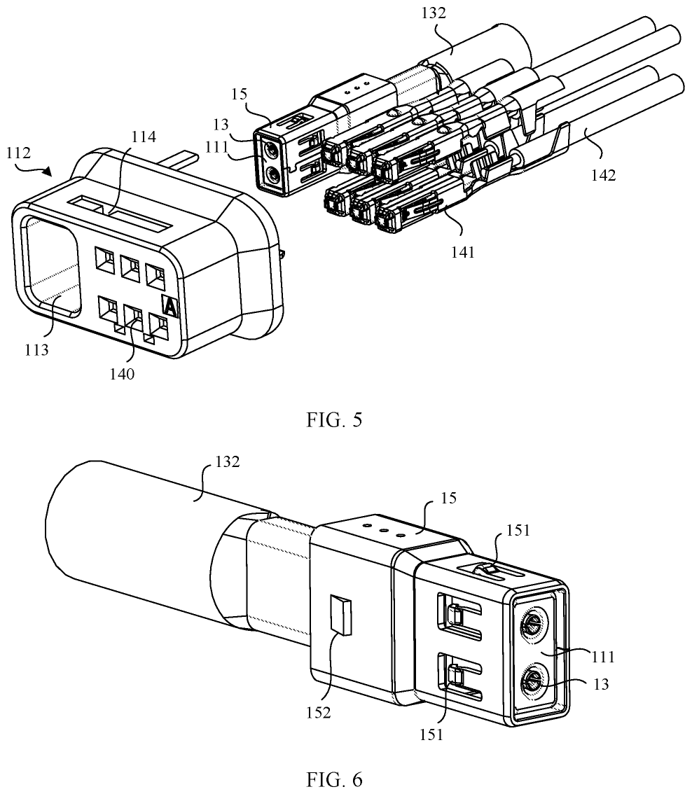

FIG. 5 is a schematic exploded view of a first insulating body according to an embodiment of this application. Refer to FIG. 5. It should be understood that, in embodiments of this application, the first jack 13 and the second jack 14 are structures for cooperatively connecting a pin and implementing an electrical connection. The first jack 13 may include an opening provided on the first support 111 and a first conductive terminal (not shown in the figure) disposed in the second support 112. The first conductive terminal is configured to connect to the first connection cable 132. The second jack 14 may include an opening 140 provided on the second support 112 and a second conductive terminal 141 disposed in the second support 112. The second conductive terminal 141 is configured to connect to the second connection cable 142.

The first conductive terminal and the second conductive terminal 141 may be a type of conductive structure like a metal spring plate, to ensure, on the basis of implementing the electrical connection, good electrical contact obtained by inserting a pin into a jack. The first connection cable 132 may be a high-speed signal cable, and the second connection cable 142 may be a low-speed signal cable. An internal conductive structure and an external protective layer structure of the first connection cable 132 are different from that of the second connection cable 142.

In embodiments of this application, the female connector 100 may further include a first shielding housing 15, the first shielding housing 15 may cover the first support 111, the first jack 13 is exposed on an opening side of the first shielding housing 15, the first shielding housing 15 may be disposed in the accommodating cavity 113, and there is a spacing between an outer wall of the first shielding housing 15 and the inner wall of the accommodating cavity 113, to further reduce electromagnetic interference between the first jack 13 and the second jack 14.

The first shielding housing 15 may be a metal piece, for example, may be an aluminum alloy. The first shielding housing 15 may cover the first jack 13, to effectively shield electromagnetic interference and improve overall structural strength of the first jack 13 and the first support 111.

FIG. 6 is a schematic diagram of a structure of a first shielding housing according to an embodiment of this application. As shown in FIG. 6, a spring plate 151 is disposed on an outer surface of the first shielding housing 15. The spring plate 151 can play a clamping function, so that after the male connector 200 is connected to the female connector 100, by using the spring plate 151, the first shielding housing 15 can be clamped on a structure that is of the male connector 200 and that is correspondingly inserted between the first shielding housing 15 and the inner wall of the accommodating cavity 113, to ensure a more stable and reliable insertion relationship. In addition, the spring plate 151 can fill a middle spacing generated by connecting the male connector 200 and the female connector 100, to play a shielding function.

In addition, in embodiments of this application, there may be a plurality of spring plates 151. An opening of the first shielding housing 15 is set to a rectangle, and the spring plate 151 is disposed on each of four side walls that correspond to four sides of the rectangle on the first shielding housing 15. For example, for the first shielding housing 15 with a rectangular opening, at least two spring plates 151 are disposed on a side wall corresponding to a long side of the rectangle, and at least one spring plate 151 is disposed on a side wall corresponding to a short side of the rectangle.

Compared with a shielding housing with a circular opening, for a shielding housing with the rectangular opening and a same shielding surface area, more spring plates 151 can be arranged to fill the middle spacing generated by connecting the male connector 200 and the female connector 100, so that the spacing is less than one-quarter wavelength of an electromagnetic wave as far as possible, to achieve a good shielding effect.

It should be understood that the opening of the first shielding housing 15 is set to the rectangle. The rectangle is not strictly limited to a quadrilateral whose four corners are right angles, but may be a chamfered rectangle whose four corners are chamfered or a rounded rectangle whose four corners are rounded. The rounded corner and the chamfered corner are arranged at the four corners of the rectangle, which has negligible influence on an overall shape of the rectangle, and is beneficial to technological processing and can prevent stress concentration. The opening of the first shielding housing 15 may alternatively be set to a hexagon or another polygon. In comparison, the opening of the first shielding housing 15 is set to the rectangle, which has advantages of simple structure and easy implementation.

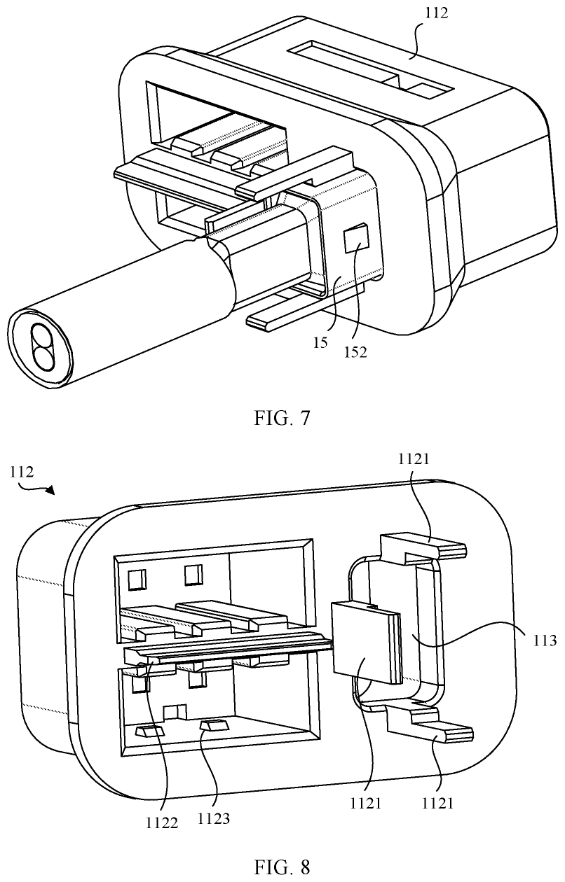

FIG. 7 is a schematic diagram of cooperation between a first shielding housing and a second support according to an embodiment of this application. Refer to FIG. 6 and FIG. 7. A stop protrusion 152 may be further disposed on the outer surface of the first shielding housing 15. The stop protrusion 152 may be disposed on a side that is of the first shielding housing 15 and that is away from the first jack 13. When the first shielding housing 15 is installed in the accommodating cavity 113 of the second support 112, the stop protrusion 152 is located outside the accommodating cavity 113, and the stop protrusion 152 may be configured to prevent the first shielding housing 15 and the first support 111 from coming out of the accommodating cavity 113.

It should be noted that the first shielding housing 15 may include a first section and a second section. The first section is close to the opening side of the first protective housing 12. A cross-sectional dimension of the first section is less than that of the second section. The spring plate 151 is disposed on the first section. The stop protrusion 152 is disposed on the second section. It is not difficult to understand that, when the first shielding housing 15 is assembled in the accommodating cavity 113, an outer wall of the first section is spaced from the inner wall of the accommodating cavity 113, and an outer wall of the second end may be in interference fit with the inner wall of the accommodating cavity 113.

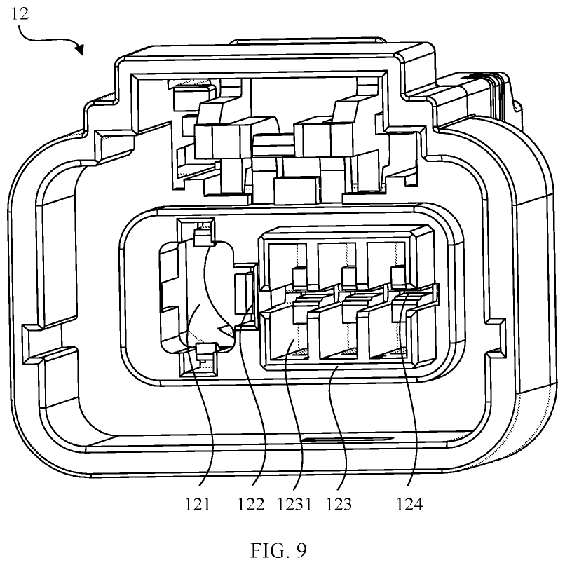

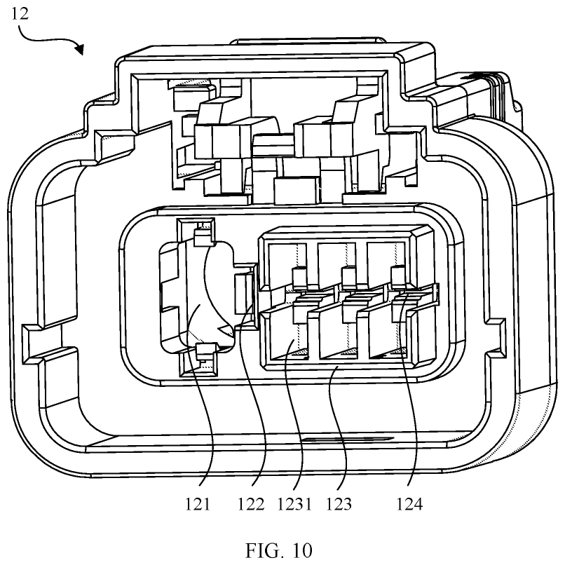

FIG. 8 is a schematic diagram of a structure of a second support according to an embodiment of this application. FIG. 9 is a schematic diagram of a structure of a first protective housing according to an embodiment of this application. FIG. 10 is a schematic diagram of a structure of a first protective housing from another angle according to an embodiment of this application. Refer to FIG. 8 to FIG. 10. In embodiments of this application, the second support 112 may be installed in the first protective housing 12, and the first protective housing 12 and the second support 112 may be connected in a manner of abutting, clamping, or the like, to jointly limit positions of the first shielding housing 15 and the second conductive terminal 141.

A first limiting cavity 121 may be disposed in the first protective housing 12. The first limiting cavity 121 may be disposed opposite to the accommodating cavity 113. The first shielding housing 15 may be installed in the first limiting cavity 121. The first limiting cavity 121 is a cavity that may also be provided with a rectangular opening. The first shielding housing 15 may be in interference fit with an inner side wall of the first limiting cavity 121. The first limiting cavity 121 may prevent the first shielding housing 15 from moving inward after being subject to an action force generated by inserting a pin into the first jack 13.

A second limiting cavity 123 may be further disposed in the first protective housing 12, and the second conductive terminal 141 may be installed in the second limiting cavity 123. After the second support 112 is installed in the first protective housing 12, the second support 112 covers the second limiting cavity 123, and the second conductive terminal 141 is clamped in the second limiting cavity 123 and is located in the second support 112. The second limiting cavity 123 can prevent the second conductive terminal 141 from moving inward after being subject to an action force generated by inserting the pin into the second jack 14.

The second limiting cavity 123 may include a plurality of sub-cavities 1231. The plurality of sub-cavities 1231 are disposed opposite to a plurality of openings 140. The plurality of second conductive terminals 141 and the plurality of sub-cavities 1231 may be disposed in a one-to-one correspondence, so that positions of the plurality of second conductive terminals 141 are reliably limited. In addition, the plurality of sub-cavities 1231 may separate the plurality of second conductive terminals 141, to avoid a contact short circuit.

In addition, a first limiting slot 122 may be disposed on the inner side wall of the first limiting cavity 121. A first limiting boss 1121 may be disposed on the second support 112. The first limiting boss 1121 is disposed on a side that faces the first limiting cavity 121 and that is of the second support 112, and is located on a peripheral side of the accommodating cavity 113. The first limiting boss 1121 may be clamped in the first limiting slot 122.

For example, there may be three first limiting slots 122 that are respectively located on three inner side walls of the first limiting cavity 121. It should be understood that the first limiting slot 122 is not disposed on the remaining side wall, to avoid the stop protrusion 152. There may be three first limiting bosses 1121. The three first limiting bosses 1121 and the first limiting slots 122 are disposed in a one-to-one correspondence. The first limiting bosses 1121 are clamped in the first limiting slot 122 to prevent the second support 112 from moving inward after being subject to a force, and limit a position of the first shielding housing 15 to prevent poor electrical contact caused by moving the first jack 13 up and down.

A buckle and the inner side wall of the first limiting cavity 121 may form the first limiting slot 122. The buckle has specific elasticity and deformation, and can be configured to clamp the first shielding housing 115.

The second limiting cavity 123 may include a second limiting slot 124. A second limiting boss 1122 is disposed on the second support 112. The second limiting boss 1122 is disposed on a side that faces the second limiting cavity 123 and that is of the second support 112. The second limiting boss 1122 is clamped in the second limiting slot 124.

Continue to refer to FIG. 8. In addition to the accommodating cavity 113, another cavity configured to accommodate the second limiting cavity 123 may be disposed on the second support 112. The cavity may be divided into an upper part and a lower part. The second limiting boss 1122 is disposed between the upper part and the lower part of the cavity. The second limiting slot 124 may be disposed between two adjacent sub-cavities 1231. The second limiting boss 1122 may be clamped in the second limiting slot 124 to prevent the second support 112 from moving inward after being subject to a force, and limit a position of the second conductive terminal 141 to prevent poor electrical contact caused by moving the second conductive terminal 141 up and down.

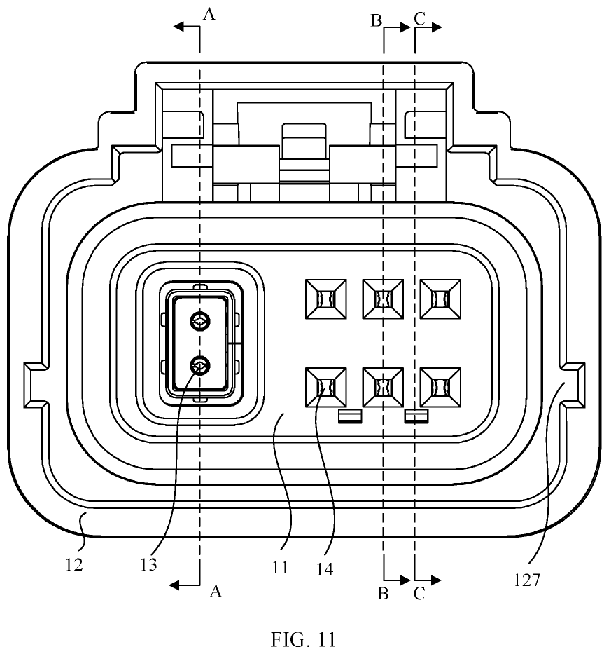

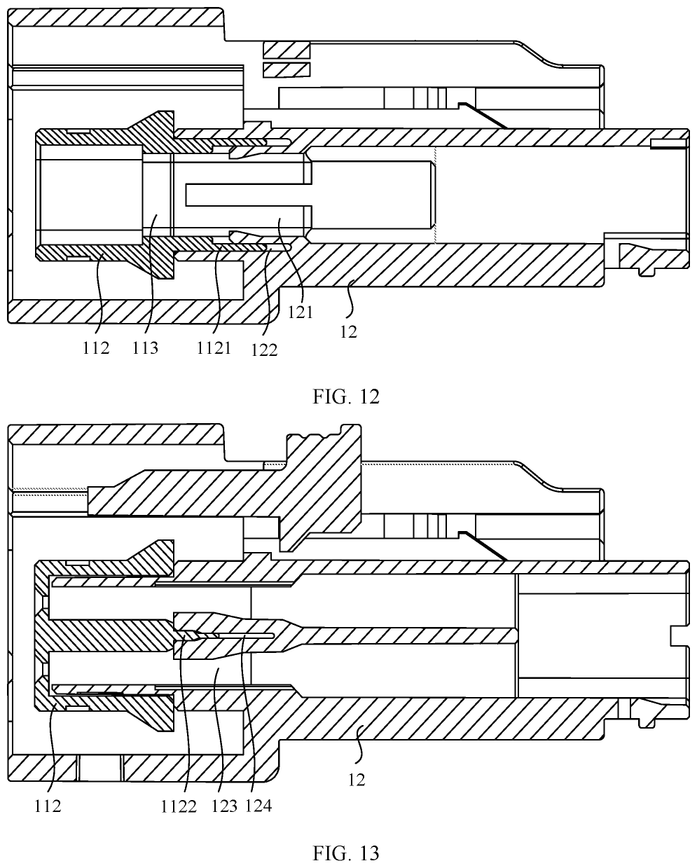

FIG. 11 is a front view of a female connector according to an embodiment of this application. FIG. 12 is a cross sectional view of FIG. 11 at A-A. For ease of understanding, structures of the first jack 13, the first support 111, and the first shielding housing 15 are omitted in FIG. 12. Refer to FIG. 11 and FIG. 12. After the second support 112 and the first protective housing 12 are assembled, the first limiting boss 1121 is clamped in the first limiting slot 122.

FIG. 13 is a cross sectional view of FIG. 11 at B-B. For ease of understanding, a structure of the second conductive terminal 141 is omitted in FIG. 13. Refer to FIG. 11 and FIG. 13. After the second support 112 and the first protective housing 12 are assembled, the second support 112 covers the second limiting cavity 123, and the second limiting boss 1122 is clamped in the second limiting slot 124.

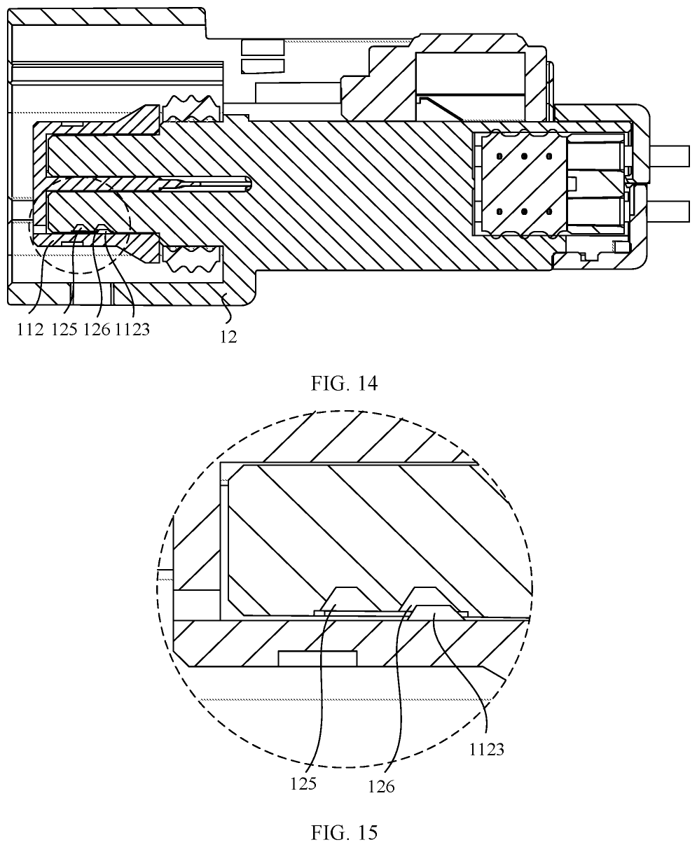

FIG. 14 is a cross sectional view of FIG. 11 at C-C. FIG. 15 is an enlarged view of a circle portion of FIG. 14. Refer to FIG. 11 to FIG. 15. A protrusion 1123 may be disposed on an inner side wall of the second support 112. A first groove 125 and a second groove 126 are disposed on an outer side wall of the second limiting cavity 123. The first groove 125 and the second groove 126 are arranged in an extension direction of the second conductive terminal. The first groove 125 is located on a side close to the second jack 14. The protrusion 1123 is configured to be clamped in the first groove 125 or the second groove 126.

There may be two or more protrusions 1123, to increase clamping reliability. There may be two or more first grooves 125 that correspond to the protrusions 1123 in quantity. The two or more first grooves 125 may be arranged in a row. There may be two or more second grooves 126 that correspond to the protrusions 1123 in quantity. The two or more second grooves 126 may be arranged in a row.

It should be noted that an assembling process of the female connector 100 may be as follows: First, the first shielding housing 15 and the second conductive terminal 141 are installed in the first protective housing 12, and then the second support 112 is pushed into the first protective housing 12 from an opening of the first protective housing 12. In this case, the protrusion 1123 on the second support 112 may be clamped in the first groove 125, which is equivalent to pre-assembly, and can ensure that the second support 112 and the first protective housing 12 are accurately positioned before assembly. Then, an inward force is continuously applied to the second support 112, and the second support 112 moves inward until the protrusion 1123 is clamped in the second groove 126, so that the second support 112 is assembled in place. After the second groove 126 and the protrusion 1123 are clamped, the second support 112 and the first protective housing 12 can be reliably fastened. In addition, the first groove 125 and the second groove 126 may be disposed, to facilitate assembly of the second support 112 and the first protective housing 12, and reduce assembly costs.

Still refer to FIG. 5. In embodiments of this application, a disassembly groove 114 may be further disposed on the first insulating body 11. The disassembly groove 114 is disposed on an outer side wall surface of the first insulating body 11, and the outer side wall surface is adjacent to a wall surface on which the first jack 13 and the second jack 14 are exposed. There may be two disassembly grooves 114 that are disposed on two opposite outer side wall surfaces of the second support 112.

When the second support 112 needs to be disassembled from the first protective housing 12, a disassembly tool may be clamped in the disassembly groove 114, to disassemble the second support 112 from the first protective housing 12. Compared with a structure in which the protrusion or a handle is disposed on the second support 112 for disassembly, the disassembly groove 114 is disposed, so that corresponding avoidance processing does not need to be performed on the male connector 200, and design costs can be reduced.

In addition, a guiding groove 127 may also be disposed on an inner side wall of the first protective housing 12, and the guiding groove 127 extends inward from the opening side of the first protective housing 12. There may be two guiding grooves 127. The two guiding grooves 127 are respectively disposed on two opposite inner side walls of the first protective housing 12, and are configured to cooperate with a structure like a guiding rib on the male connector 200 to play a guiding function, to facilitate a connection between the female connector 100 and the male connector 200.

According to the female connector provided in embodiments of this application, a first jack configured to transmit high-speed Ethernet data and a second jack configured to transmit a low-speed CAN signal and/or a power supply can be integrated into the first protective housing, to reduce a volume of the connector and plug-in and out durability. In addition, electromagnetic interference between the first jack and the second jack can be reduced by disposing the first shielding housing. In addition, structures such as a boss and a clamping slot that cooperate with each other on a first support body and the first protective housing can limit positions of the first jack and the second jack in design, to prevent poor electrical contact caused by displacement.

With reference to the accompanying drawings and specific embodiments, the following describes in detail a structure of the male connector provided in this application.

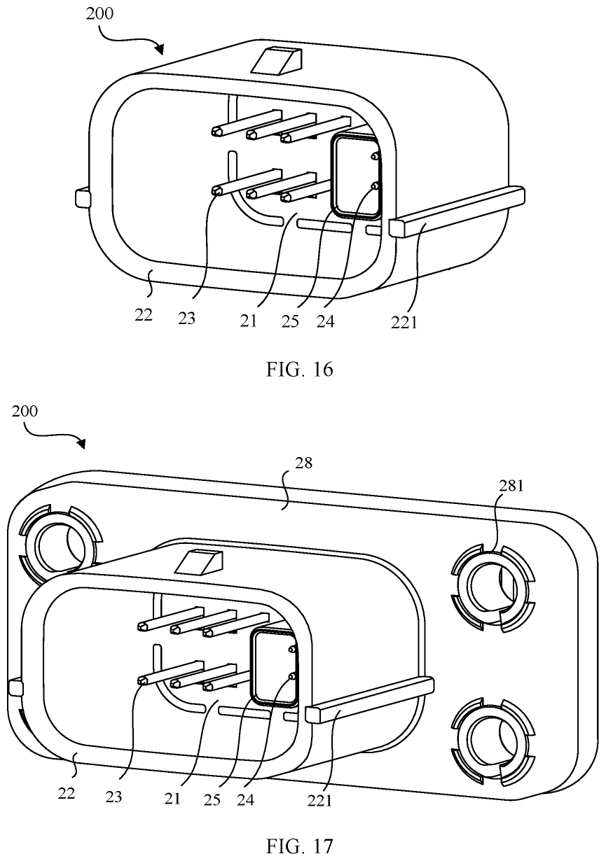

FIG. 16 is a schematic diagram of a structure of a male connector according to an embodiment of this application. Refer to FIG. 16. An embodiment of this application provides the male connector 200, which may include a second insulating body 21, a second protective housing 22, a first pin 23, and a second pin 24. The first pin 23 and the second pin 24 may be convexly disposed on the second insulating body 21. The second protective housing 22 is connected to the second insulating body 21. The second protective housing 22 is disposed around the first pin 23 and the second pin 24. The first pin 23 and the second pin 24 are exposed on an opening side of the second protective housing 22. There is a spacing between the first pin 23 and the second pin 24. The first pin 23 and the second pin 24 are respectively configured to transmit signals with different rates.

The first pin 23 may be configured to transmit the high-speed Ethernet data. The second pin 24 may be configured to transmit the low-speed CAN signal and/or the power signal. There is a spacing between the first pin 23 and the second pin 24, to reduce mutual influence between signals. Compared with a manner in which each of the first pin 23 and the second pin 24 is disposed in one protective housing, a manner in which the first pin 23 and the second pin 24 are integrated into the second protective housing 22 can reduce a volume of the male connector 200, facilitate a connection, and improve installation efficiency.

It should be noted that, in embodiments of this application, shapes of the second insulating body 21 and the second protective housing 22 are not specifically limited. An opening of the second protective housing 22 may be a rectangle, an ellipse, a polygon, or another shape. A shape of the second insulating body 21 exposed on the opening side of the second protective housing 22 may be similar to that of the second protective housing 22. In embodiments of this application, the opening of the second protective housing 22 may be a rounded rectangle. The shape is merely a possible implementation, and does not limit a structure of the second protective housing 22.

Refer to FIG. 3. The first pin 23 is configured to be inserted into the first jack 13 and conduct a power connection, to transmit the high-speed Ethernet data. The second pin 24 is configured to be inserted into the second jack 14 and conduct a power connection, to transmit the low-speed CAN signal and the power signal. The first pin 23 and the second pin 24 are disposed corresponding to the first jack 13 and the second jack 14 in quantity and arrangement. Details are not described herein again.

When the female connector 100 and the male connector 200 are cooperatively connected, the second protective housing 22 is inserted into accommodating space between the first protective housing 12 and the first insulating body 11. The second protective housing 22 and the first protective housing 12 are similar in shape, and both may be set to rounded rectangles.

A guiding rib 221 may be disposed on an outer side wall of the second protective housing 22. The guiding rib 221 extends in a direction close to the second insulating body 21 from the opening side of the second protective housing 22. An extension direction of the guiding rib 221 is consistent with an extension direction of the first pin 23 and the second pin 24. The guiding rib 221 is configured to be clamped in the guiding groove 127 and move in the guiding groove 127, so that the female connector 100 can move along a fixed position when being inserted into the male connector 200. In addition, the guiding function facilitates smooth insertion cooperation between a pin and a jack.

In addition, in embodiments of this application, the male connector 200 may further include a second shielding housing 25. The second shielding housing 25 may be disposed around the first pin 23. The first pin 23 is exposed on an opening side of the second shielding housing 25. When the female connector 100 and the male connector 200 are cooperatively connected, the second shielding housing 25 is inserted between the first support 111 and the accommodating cavity 113.

The second shielding housing 25 may be a metal piece, for example, may be an aluminum alloy. The second shielding housing 25 may cover the first pin 23, to effectively shield electromagnetic interference.

In addition, when the first shielding housing 15 is disposed on the female connector 100, the second shielding housing 25 is inserted between the first shielding housing 15 and the accommodating cavity 113. When the spring plate 151 is disposed on the outer surface of the first shielding housing 15, the spring plate 151 is clamped on an inner wall of the second shielding housing 25.

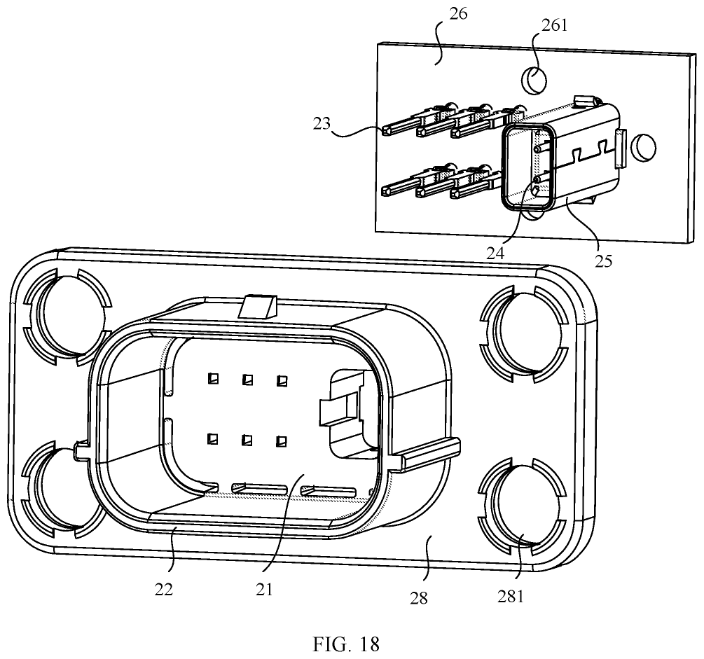

FIG. 17 is a schematic diagram of another structure of a male connector according to an embodiment of this application. Refer to FIG. 17. The male connector 200 further includes a mounting plate 28. The mounting plate 28 is connected to a periphery of the second insulating body 21. A mounting hole 281 is disposed on the mounting plate 28. The mounting hole 281 is configured to mount a threaded fastener to fasten the male connector 200 to a to-be-installed device. The to-be-installed device may be a vehicle-mounted device, for example, a vehicle-mounted lidar or a domain controller.

There may be, for example, four mounting holes 281. The mounting holes 281 can be disposed at four corners of the mounting plate 28, to better fasten the mounting plate 28 to the to-be-installed device without loosening.

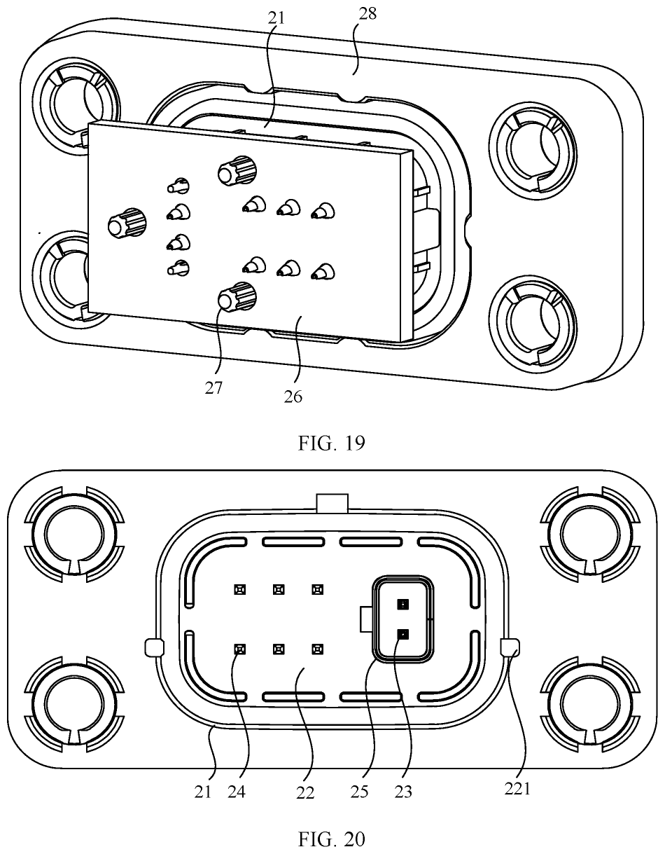

FIG. 18 is a schematic exploded view of a male connector according to an embodiment of this application. FIG. 19 is a schematic diagram of a structure of a male connector from another angle according to an embodiment of this application. Refer to FIG. 18 and FIG. 19. In embodiments of this application, the male connector 200 may further include a circuit board 26. The circuit board 26 may be disposed on a side that is far away from the second protective housing 22 and that is of the second insulating body 21. The first pin 23 and the second pin 24 penetrate in through holes of the second insulating body 21 and are fastened to the circuit board 26.

The first pin 23 and the second pin 24 may penetrate the second insulating body 21 and be soldered on the circuit board 26, to implement an electrical connection to the circuit board 26 while being reliably fastened.

The second shielding housing 25 may penetrate in a through hole of the second insulating body 21 and be fastened to the circuit board 26; or the second shielding housing 25 may be soldered on the circuit board 26 or clamped and fastened to the circuit board 26 by using a bending structure. In this case, the second shielding housing 25 may cover an entire length of the first pin 23, to achieve a good shielding effect.

Three positioning pins 27 are further disposed on the second insulating body 21, and are arranged in a triangle to form a stable triangle structure. Three positioning holes 261 are disposed on the circuit board 26. The positioning pin 27 penetrates in the positioning hole 261. When the first pin 23 and the second pin 24 are soldered on the circuit board 26, the circuit board 26 can be pre-positioned through cooperation between the positioning pin 27 and the positioning hole 261, to prevent a pin damage or a soldering failure caused by moving the circuit board 26 in a soldering process. It is not difficult to understand that there may be at least three positioning pins 27 to form the triangular structure. In addition, a quantity of positioning pins may be increased, to increase stability or replace the triangular structure.

For the male connector provided in embodiments of this application, a first pin configured to transmit the high-speed Ethernet data and the second pin configured to transmit the low-speed CAN signal and/or the power signal can be integrated into the second protective housing, to reduce a volume of the connector, an area of the circuit board, and plug-in and out durability. In addition, electromagnetic interference between the first pin and the second pin can be reduced by disposing the second shielding housing.

An embodiment of this application further provides a connector assembly. The connector assembly includes the female connector 100 and the male connector 200 provided in the foregoing embodiments. Specific structures of the female connector 100 and the male connector 200 are not described herein again.

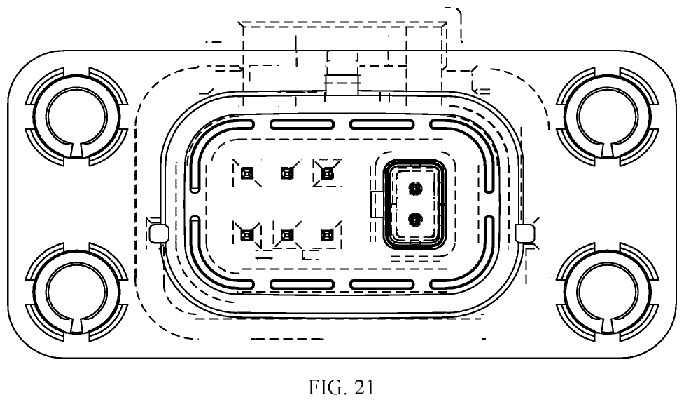

FIG. 20 is a front view of a male connector according to an embodiment of this application. FIG. 21 is a schematic diagram of cooperation between a female connector and a male connector according to an embodiment of this application. Refer to FIG. 11, FIG. 20, and FIG. 21. When the female connector 100 and the male connector 200 are cooperatively connected, the first pin 23 is inserted into the first jack 13, and the second pin 24 is inserted into the second jack 14. The second protective housing 22 is inserted into the accommodating space between the first protective housing 12 and the first insulating body 11. The second shielding housing 25 is inserted between the first shielding housing 15 and the accommodating cavity 113. The spring plate 151 is clamped on the inner wall of the second shielding housing 25. The guiding rib 221 is clamped in the guiding groove 127.

For example, a high-speed transmission cable is configured to transmit the high-speed Ethernet data, and a low-speed transmission cable is configured to transmit the low-speed CAN signal and/or the power signal. This is not limited in this application, provided that the structure may be used for a connection requirement that a device vendor has different transmission rate requirements, to reduce a size requirement of a connection end, facilitate device miniaturization, and reduce a cabling requirement of an application scenario (for example, a vehicle) of a device.

For the connector assembly provided in embodiments of this application, a high-speed connector configured to transmit a high-speed signal and a low-speed connector configured to transmit a low-speed signal can be combined, to reduce a volume of the connector, and simultaneously transmit the high-speed signal and the low-speed signal by wiring only once. Convenience and efficiency of a user operation can be improved by reducing plug-in and out durability of the connector. In addition, manufacturing costs of the connector can be greatly reduced by combining the two connectors.

In addition, an embodiment of this application further provides a vehicle-mounted device. The female connector or the male connector provided in embodiments of this application may be disposed on the vehicle-mounted device.

An embodiment of this application further provides a cable. The female connector or the male connector provided in embodiments of this application may be disposed on the cable.

In a possible implementation, refer to FIG. 1 and FIG. 2. The male connector 200 may be disposed on the vehicle-mounted device 500. The female connector 100 may be disposed on the cable 400. The male connector 200 and the female connector 100 may be cooperatively connected to transmit a signal between the cable 400 and the vehicle-mounted device 500.

According to the female connector 100 provided in embodiments of this application, because cooperative structures between a jack, a conductive terminal, and a housing inside the female connector are more complex than that of the male connector 200, the female connector 100 is connected to the cable 400, so that the female connector 100 is easily disassembled and maintained after being damaged, and the female connector may be directly replaced with a new product in the event of a serious damage. Therefore, costs are low. Compared with the female connector 100, the male connector 200 has a simple internal structure and is not easily damaged. The male connector 200 can be installed on the vehicle-mounted device 500, to reduce a damage probability and maintenance costs of the vehicle-mounted device 400. In addition, when a user holds the cable 400 and inserts the female connector 100 with a jack into the male connector 200 with a pin, it is difficult for the user to touch the live pin. This provides high security.

An embodiment of this application may further provide a terminal. The terminal may include the female connector or the male connector provided in embodiments of this application. The terminal may be a device, for example, a vehicle, a ship, an aircraft, or a spacecraft. A connector assembly used in each of these terminals may be a power connector, a high-speed signal connector, an aviation connector, an optical fiber connector, or the like.

The connector provided in embodiments of this application that combines the high-speed connector and the low-speed connector can be used in the terminal, to reduce plug-in and out durability and facilitate a miniaturized design of the terminal.

Finally, it should be noted that the foregoing embodiments are merely intended for describing the technical solutions of embodiments of this application other than limiting embodiments of this application. Although embodiments of this application are described in detail with reference to the foregoing embodiments, a person of ordinary skill in the art should understand that the person of ordinary skill in the art may still make modifications to the technical solutions described in the foregoing embodiments or make equivalent replacements to some or all technical features thereof, without departing from the scope of the technical solutions of embodiments of this application.

1. A female connector, comprising;
a first protective housing;
a first insulating body disposed in the first protective housing, wherein the first insulating body comprises a first opening side, a first support, and a second support; and
a first jack provided on the first insulating body; and
a second jack provided on the first insulating body,
wherein the first jack is provided on the first support,
wherein the second jack is provided on the second support,
wherein the first jack and the second jack are exposed on the first opening side,
wherein there is a first spacing between the first jack and the second jack, and
wherein the first jack and the second jack are respectively configured to transmit signals with different rates.

2. The female connector of claim 1, wherein the female connector further comprises an accommodating cavity having an inner wall and provided on the second support, wherein the first support is installed in the accommodating cavity, and wherein there is a second spacing between the first support and the inner wall.

3. The female connector of claim 2, wherein the female connector further comprises a first shielding housing comprising an outer wall and a second opening side, wherein the first shielding housing covers the first support, wherein the first jack is exposed on the second opening side, wherein the first shielding housing is disposed in the accommodating cavity, and wherein there is a third spacing between the outer wall and the inner wall.

4. The female connector of claim 3, wherein the first shielding housing further comprises an outer surface, and wherein the female connector further comprises a spring plate disposed on the outer surface.

5. The female connector of claim 4, wherein the first shielding housing further comprises a rectangular opening, and wherein the spring plate is disposed on each of four side walls that correspond to four sides of a rectangle on the first shielding housing.

6. The female connector of claim 3, further comprising a first limiting cavity provided in the first protective housing, wherein the first limiting cavity is provided opposite to the accommodating cavity, and wherein the first shielding housing is installed in the first limiting cavity.

7. The female connector of claim 6, wherein the second support comprises a first side that faces the first limiting cavity, wherein the accommodating cavity comprises a peripheral side, and wherein the female connector further comprises:
a first limiting slot provided on an inner side wall of the first limiting cavity; and
a first limiting boss disposed on the second support, wherein the first limiting boss is:
disposed on the first side;
located on the peripheral side; and
clamped in the first limiting slot.

8. The female connector of claim 2, further comprising:
a first conductive terminal disposed in the first jack, wherein the first conductive terminal is configured to connect to a first connection cable; and
a second conductive terminal disposed in the second jack, wherein the second conductive terminal is configured to connect to a second connection cable.

9. The female connector of claim 8, further comprising a second limiting cavity provided in the first protective housing, wherein the second conductive terminal is installed in the second limiting cavity, and wherein the second support covers the second limiting cavity.

10. The female connector of claim 9, wherein the second support comprises a second side that faces the second limiting cavity, wherein the second limiting cavity comprises a second limiting slot, wherein the female connector further comprises a second limiting boss disposed on the second side of the second support, and wherein the second limiting boss is clamped in the second limiting slot.

11. The female connector of claim 9, wherein the second limiting cavity comprises an outer side wall, wherein the second support comprises an inner side wall, and wherein the female connector further comprises:
a first groove and a second groove disposed on the outer side wall, wherein the first groove and the second groove are arranged in an extension direction of the second conductive terminal, wherein the first groove is located on a side closest to the second jack; and
a protrusion disposed on the inner side wall, wherein the protrusion is configured to be clamped in the first groove or the second groove.

12. The female connector of claim 9, further comprising a plurality of second conductive terminals, wherein the second conductive terminal is one of the plurality of second conductive terminals, wherein the second limiting cavity comprises a plurality of sub-cavities, and wherein the plurality of second conductive terminals and the plurality of sub-cavities are disposed in a one-to-one correspondence.

13. The female connector of claim 2, wherein the first insulating body comprises an outer side wall surface, and wherein the female connector further comprises a disassembly groove disposed on the outer side wall surface.

14. The female connector of claim 1, wherein the first protective housing comprises an inner side wall, wherein the female connector further comprises a guiding groove disposed on the inner side wall, and wherein the guiding groove extends inward from the first opening side.

15. A male connector, comprising;
a second insulating body;
a first pin;
a second pin; and
a second protective housing comprising a first opening side and connected to the second insulating body,
wherein the second protective housing is disposed around the first pin and the second pin,
wherein the first pin and the second pin are convexly disposed on the second insulating body,
wherein the first pin and the second pin are exposed on the first opening side,
wherein there is a spacing between the first pin and the second pin, and
wherein the first pin and the second pin are respectively configured to transmit signals with different rates.

16. The male connector of claim 15, further comprising a second shielding housing comprising a second opening side is disposed around the first pin, wherein the first pin is exposed on the second opening side.

17. The male connector of claim 16, further comprising a circuit board disposed on a side that is away from the second protective housing and that is of the second insulating body, wherein the first pin and the second pin penetrate in through holes of the second insulating body and are fastened to the circuit board.

18. The male connector of claim 17, wherein the second shielding housing penetrates in a through hole of the second insulating body and is fastened to the circuit board.

19. The male connector of claim 17, wherein the second insulating body is provided with three positioning pins, wherein the three positioning pins are arranged as a triangle, wherein the circuit board is provided with three positioning holes, and wherein each positioning pin of the three positioning pins penetrates a positioning hole of the three positioning holes.

20. The male connector of claim 15, wherein the second protective housing comprises an outer side wall, wherein the male connector further comprises a guiding rib disposed on the outer side wall, wherein the guiding rib extends in a direction from the second insulating body to the first opening side, and wherein an extension direction of the guiding rib is consistent with an extension direction of the first pin and the second pin.

21. The male connector of claim 15, further comprising:
a mounting plate connected to a periphery of the second insulating body; and
a mounting hole provided on the mounting plate, wherein the mounting hole is configured to mount a fastener to fasten the male connector to a to-be-installed device.
